(19) United States
(12) Patent Application Publication
(10) Pub. No.: US 2010/0162809 A1
(43) Pub. Date: Jul. 1, 2010

(54) FLOW RATE SENSOR FOR WATER DUCTS AND A METHOD FOR MEASURING WATER FLOW

(75) Inventors: Peter LANGE, Kaaks (DE); Lorenzo BERTINI, Ponsacco (IT); Massimiliano MELANI, Vinci (IT); Francesco BRANCHITTA, Pisa (IT)

Correspondence Address: DENNISON, SCHULTZ & MACDONALD, 1727 KING STREET, SUITE 105, ALEXANDRIA, VA, 22314, US

(73) Assignees: ACQUE INGEGNERIA S.R.L., Pisa (IT); SENSORDYNAMICS AG, Graz-Lebring (AT)

(21) Appl. No.: 12/596,934

(22) PCT Filed: May 10, 2007
(86) PCT No.: PCT/IB07/01204

§ 371 Date: Nov. 24, 2009

(51) Int. Cl. G01F 1/69; B23P 17/04

(52) U.S. Cl. 73/204.25; 29/428

(57) ABSTRACT

A water flow rate sensing device for water ducts, comprising a thermal sensor (20) capable of measuring the flow by measuring the removal of heat by a heater from the water; an elongated support (9)/in particular, tubular, having the sensor (20) mounted at a free end thereof so that the support is inserted laterally with respect to the duct through a hole and cantilevered in order to keep the sensor in a central zone of the duct. The free end of the support comprises a lamina-shaped extension member. Furthermore, the device comprises means (5,7) for transmitting a measuring signal to a remote control unit. The invention comprises also a method for measuring the water flow.

### FIELD OF THE INVENTION

The present invention relates to devices for measuring physical parameters of a fluid flow and, in particular, it relates to a flow rate sensor for water flowing in water ducts.

### BACKGROUND OF THE INVENTION

The need is felt of measuring the flow rate in pipes of water ducts and, in particular, of testing flow data in the same, on the one hand for checking the water consumption in the net and on the other hand for determining where large water losses or break of ducts occur.

For monitoring the flow, many sensors should be provided along the pipes of a net, and such sensors should be very cheap and easy to clean or to change without the need of stopping the flow.

Many sensors exist, of different nature, capable of measuring the flow rate in ducts. Among them thermal electronic solid state sensors exist capable of measuring the flow by measuring the heat transferred by a resistor to a liquid and, in particular, the temperature difference between a heater and a thermoresistance. An example of such sensors is described in U.S. Pat. No. 6,494,090.

Such sensors, moreover, preferably communicate the measured data to a control system, causing, in the known devices, high costs for creating cable connections with the result of a too low number of sensors mounted in a pipeline, sometimes insufficient for a precise flow control.

Furthermore, known sensors that exploit this thermo-dynamic principle have the drawback that, during the measure, the heat of the resistor produces vapour bubbles, which in part remain attached to the sensor and in part are removed by the flow. Such bubbles, create an insulation around the sensor and negatively affect the flow measurements. The sensors that exploit this thermo-dynamic principle furthermore, enhance the deposit of calcium carbonate (limestone) on the hot surfaces, degrading with time the functionality of the sensor.

### SUMMARY OF THE INVENTION

Therefore, it is a feature of the invention to provide a water flow rate sensing device for water ducts, having a thermal flow rate sensor, which is of quick and easy installation without stopping the water flow.

Another feature of the invention is to provide a water flow rate sensing device for water ducts capable of positioning a thermal flow rate sensor in a substantially central position with respect to the flow, where the flow is not much influenced by the walls of the duct.

A further feature of the invention is to provide a water flow rate sensing device for water ducts capable of cheaply communicating with a central control unit.

Another feature of the invention is to provide a water flow rate sensing device for water ducts, capable of avoiding the problem of the production of gas bubbles and the deposit of such bubbles on the surface of the sensor during the measurements.

Another feature of the invention is to provide a water flow rate sensing device for water ducts, capable of minimizing the sensor degradation owing to the deposit of calcium carbonate.

A further feature of the invention is to provide a water flow rate sensing device for water ducts, which allows discriminating the direction of the water flow in the pipes, by compact a flow rate solid state thermal sensor.

A further feature of the invention is to provide a method that allows measuring the water flow for water ducts that achieves the above described objects.

These and other objects are fulfilled, with reference to a first aspect of the invention, by a water flow rate sensing device for water ducts, comprising:
a solid state thermal sensor having at least one heater and at least one thermoresistance at a same temperature of the water, said sensor being adapted to measure the flow rate by measuring the temperature difference between said at least one heater and said at least one thermoresistance, supplying an outlet signal proportional to said flow;
a support for said sensor, having elongated shape with a first and a second end, said sensor being of said support, said first end being adapted to be inserted in a hole made in a duct in order to support said sensor in an inner point of said duct in a zone of flow distant from the walls of the duct;
fastening means to keep said support in said hole, so that said support has said first end in said duct.

Advantageously, said support provides a lamina-shaped extension member to it integrally connected at said first end and adapted to be put in the water flow, said extension member holding said sensor distanced from said first end.

Advantageously, said extension member comprises first electric contacts adapted to be coupled with respective electric contacts made in said support at said first end, said lamina having longitudinal electric paths for connecting said first contacts of said lamina with a housing for said sensor, in said housing said lamina having second electric contacts for coupling to respective contacts present in said sensor.

Advantageously, said solid state thermal sensor has a first heater and a first thermoresistance placed adjacent to one another, along the direction of the flow, as well as a second heater and a second thermoresistance, in particular, said first and second thermoresistances being interdigited to each other.

This way, said support, said lamina and said sensor can be provided separately and assembled easily reducing the costs.

In particular, said lamina can be made in different lengths responsive to the diameters of the duct where the flow rate sensor according to the invention has to be applied.

Advantageously, said lamina is made of ceramic and said paths are made with the thick film technology.

Preferably, said lamina has a section adapted to a use in fluid dynamics, and said sensor is inserted at one end of said lamina in order not to offer edges to the water flow, said lamina having a recess for receiving the sensor.

This way, such a sensor is capable of determining the flow direction of the water in addition to its intensity; in fact, since the first and the second thermoresistances are interdigited to each other, they are at a same temperature coincident to that of the water, whereas the first heater is located upstream and the second heater downstream from the flow, the second heater exchanging heat less than the first heater owing to the water flow, thus determining the flow direction by the difference of the signals obtained from the two couples of heaters and thermoresistances.

Advantageously, said sensing device comprises means to supply electric energy to said sensor, selected from the group comprised of:
a battery integrated to said support;
an external source of electric energy connected to said sensing device at said second end of said support.
a self feeding device that uses the kinetic energy associated with the motion of the water in the duct, in particular, based on “energy harvesting” techniques.

In particular, said battery can be rechargeable by an electric connection to the outside.

Advantageously, said sensing device comprises means for transmitting said measuring signal to a remote central control unit.

In particular, said means for transmitting is selected from the group comprised of:
a sender of electromagnetic signals associated with said sensing device and a receiver of electromagnetic signals arranged remotely and connected to said central control unit;
an electric connection between said sensing device and said central control unit.

In particular, said support has tubular shape with closed ends, containing said battery and said means for transmitting.

In particular, said tubular support comprises a portion that can be opened for replacing the battery.

In particular, said releasable fastening means of said support in said hole is selected from the group comprised of:
an external threaded portion on said support and an internal threaded portion in said hole;
a flange integral to said support and that can be fixed to said duct;
releasable sealed lock means.

Advantageously, said water flow rate sensing device for water ducts comprises means for driving said sensor in a pulsed way by the electric power that has to be dissipated by the sensor. This way, the gas or vapour bubbles, which are formed by heating on the surface of the sensor after a certain period during the measuring step, are removed by the water flow between two measuring steps, avoiding noise disturbing the measure and the production of deposits.

Advantageously, said water flow rate sensing device for water ducts comprises means for driving said sensor maintaining the heating element of the sensor at a temperature difference with respect to the water less than 50° C. This way, by using a pulsed operation and, furthermore, maintaining the heater at a temperature difference with respect to the water less than 50° C., the production of bubbles on the surface of the sensor and the deposit of calcium carbonate are inhibited.

According to another aspect of the present invention, the above described objects are achieved by a method for measuring the water flow in water ducts, by a water flow rate sensing device for water ducts having a thermal flow rate sensor, characterised by the steps of:
arranging said sensor in the duct in order to be surrounded by the flow in a zone of the flow significant for the measure, in particular, in a zone sufficiently far from the walls of the duct;
driving said sensor in a pulsed way with a signal at the electric power that has to be dissipated by the sensor, said step of driving comprising a succession of supply time having a duration T1, with time-outs having a duration T2.

In particular, in said duration T1 of said supply time the power of the signal is changed by a feedback control capable of keeping a predetermined temperature difference between the heater of the sensor and the water, balancing the variation of the water flow rate with a suitable variation of the amplitude of the supply signal. This way, the supply signal amplitude is the information relative to the measurement of the water flow rate.

In particular, said predetermined temperature difference is less than 50° C.

Advantageously, a step is provided of discrimination of the direction of the water flow by the presence of two couples of heaters and thermoresistors.

Alternatively, said supply time has a fixed duration T1 set between 0.1 and 8 seconds, preferably 4 seconds, and said time-outs have duration T2 longer than 0.1 seconds.

### BRIEF DESCRIPTION OF THE DRAWINGS

The invention will be made clearer with the following description of an exemplary embodiment thereof, exemplifying but not limitative, with reference to the attached drawings wherein:

FIGS. 1 and 2 show, respectively, a perspective view and a top plan view of a solid state thermal sensor of known type, adapted to measure a flow of a gaseous or liquid fluid;

FIG. 3 shows such a known sensor mounted on an extension plate of alumina having the above described sensor at one end and a plurality of contact pads at the other, for fixing to a support;

FIG. 4 shows a perspective view of the application of two sensors according to the invention, mounted along a duct so that the flow rate sensors are located far from zones of higher turbulence;

FIG. 4A shows a cross sectional view of such an application of a sensor according to the invention to a duct through a flange connected to the duct same;

FIG. 5 shows the same application in a longitudinal cross section of the duct;

FIG. 6 shows a perspective view of a sensor according to the invention with a flow rate sensor mounted on an end thereof and having an electric external supply;

FIG. 7 shows an elevational side view of such a sensor;

FIG. 8 shows a cross sectional view of a sensor according to the invention, containing inside at least one electric battery and an electronic control circuit, having, furthermore, an antenna for wireless communication of the measured flow data;

FIG. 9 shows a cross sectional view of a duct where a sensing device according to the invention is mounted, where it is shown the production of bubbles of vapour that remain on the surface of the sensor, that can be avoided by a pulsed and controlled power supply to the sensor;

FIG. 10 shows an example of a pulsed feeding current of the sensor versus measuring time.

### DESCRIPTION OF THE PREFERRED EXEMPLARY EMBODIMENT

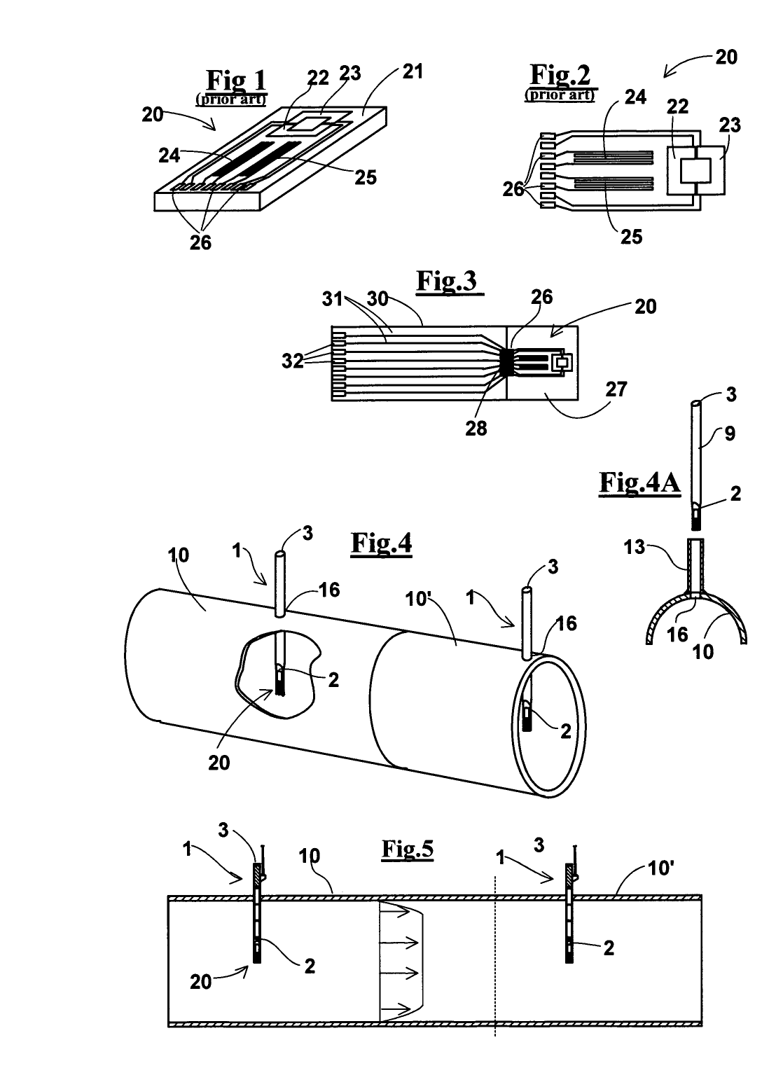

With reference to FIGS. 1 and 2, a known flow rate sensor 20 is described, whose operation is based on the measurement of removal of heat, which is provided by a resistor, by the water that flows in the duct where the sensor is mounted. Such a sensor has a support plate 21 and comprises at least one heater, 24 and 25, and at least one thermoresistance, 22 and 23, mounted on distinct circuits having respective contact pads at an end. In an exemplary embodiment, the two thermoresistances 22 and 23 can be interdigited to each other creating a single central rectangle, as described in U.S. Pat. No. 6,494,090. This way the detected signal allows discriminating the direction of the flow, being thermoresistances 22 and 23 interdigited, and at the same temperature, coincident to that of the water, and being a heater 25 located upstream from the flow same and the other heater 24 downstream of it. This arrangement requires that the second heater 24 exchanges less heat owing to the convective action of the water flow, thus determining the flow direction by the difference of signals obtained from the two couples 22, 24 and 23, 25 of heaters and thermoresistances.

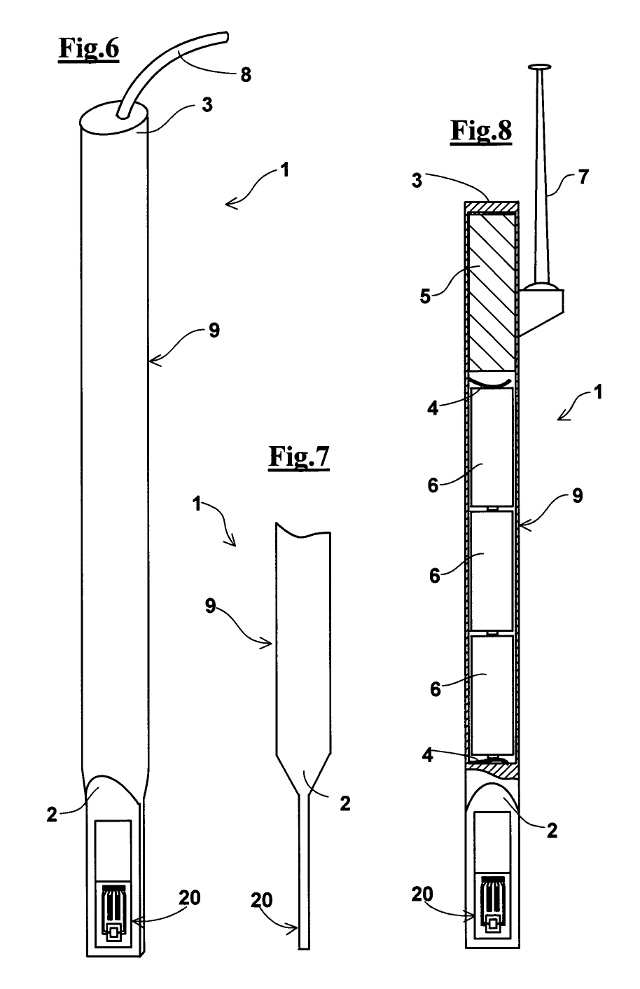

The above described sensor is, moreover, mounted at the end of a lamina-shaped plate of alumina 30 that is then connected at one end 2 of sensing device 1 according to the invention, shown in FIGS. 6, 7 and 8. Plate 30 integrates at one end sensor 20 and at the other end a plurality of contact pads 32 for connection to the sensor. At each contact 26 of the sensor a corresponding contact 28 is provided on plate and between each contact 28 and a corresponding contact 32 a lead wire is provided that connects them.

Once mounted sensor 20 on plate 30 each contact 26 of sensor 20 and the corresponding contact 28 on plate 30 are connected by “bonding”.

Contact pads 28 are associated to connection paths of that come from contact pads 32 and are obtained with the thick film technology.

The lamina plate 30 has fluidodynamic shape and is arranged parallel to the flow to minimize turbulences and resistance to flow. The free end 2 of the support may have a zone bent downwards for housing the sensor 20, so that sensor 20 does not protrude from lamina 30.

In a possible exemplary embodiment shown in FIG. 3, on lamina 30 a protection layer 27 is applied made of preformed steel with a substantially central opening adapted to contain sensor 20.

The sensing device according to the invention, as shown in FIGS. 6 and 8 comprises a support 9, for example a tubular support having a first end 2 adapted to house sensor 20 and a second opposite end 3, adapted to remain operatively external to the duct. The first end 2 can comprise a flattened portion adapted to be arranged parallel to the flow for not creating hydrodynamic resistance. Sensing device 1 according to the invention, can use an external source of electric energy and a cable 8 for transmitting the measured data to a central external control unit. In this case since the power supply is external, it is not necessary to open the support after assembling, so that the support can be sealed, for example by welding or filling it with an insulating polymer or wax or a hardening material in general. This way there are no parts that can be opened so that the sensing device can last a longer time.

Alternatively, sensing device 1, as shown in FIG. 8, can comprise a source of electric energy in the support same; in particular, if the support is tubular, a plurality of batteries 6 can be inserted inside capable of feeding sensor 20 and a control circuit 5, connected to an antenna 7 for transmitting the measured data towards an external control unit, for example by means of a wireless connection. For changing the batteries 6 when exhausted, a portion can be provided that can be opened, not shown, of support 9. Alternatively, the batteries 6 can be recharged by an outer loading unit connected by an electric cable, and also in this case a sealing step may be provided for support 9 in the way above described.

Such a sensing device is very inexpensive, since the sensors are produced in a large quantity and also the remainder of the parts is not very expensive, which can lead to use of not rechargeable and sealed batteries, adapted to be replaced easily when the batteries are exhausted.

Furthermore, such a sensor, besides being not expensive and of easy replacement, can be mounted without any cables, limiting substantially the costs of installation. In fact, as shown in FIGS. 4 and 5 many sensing devices 1 can be mounted along the ducts 10 and 10′ of water distribution pipelines, allowing a punctual monitoring. More in detail, FIG. 4 shows a perspective view of the application of two sensing devices 1, mounted along a duct 10 and 10′ so that the flow rate sensors 20 are located far from the zones of higher turbulence. FIG. 5 shows the same application but in a longitudinal cross section of the duct.

FIG. 4A shows the details of assembling steps of a sensing device 1 to a duct 10 by a metal tubular collar 13. Collar 13 has the same inner diameter of the outer diameter of support 9, and an appropriate length. The collar 13 is welded out of duct 10, with axis orthogonal to the side surface of duct 10. Then in it in a special drill tip is put, not shown in the figure, and a hole 16 is made in the duct. At the end of the drilling step of hole 16 the drill tip is partly withdrawn. Collar 13 has a side slit orthogonal to its axis not shown in the figure, in which a block can be put, not shown, which works as a gate. This way, while the drill tip is extracted, the lamina shaped plate is inserted for preventing to water to come out. Once extracted the tip the support 9 is introduced, checking that the block is extracted at a right moment. This way, the water is prevented from exiting from the collar. Then, the support is caused to penetrate in the hole of the duct, in order to position suitably the lamina.

Releasable lock means can be provided for support 9 in collar 13, or alternatively support an collar are welded. In the latter case, the device 1 once broken or exhausted, can be left in the duct, and replaced making a hole in another point of duct 10.

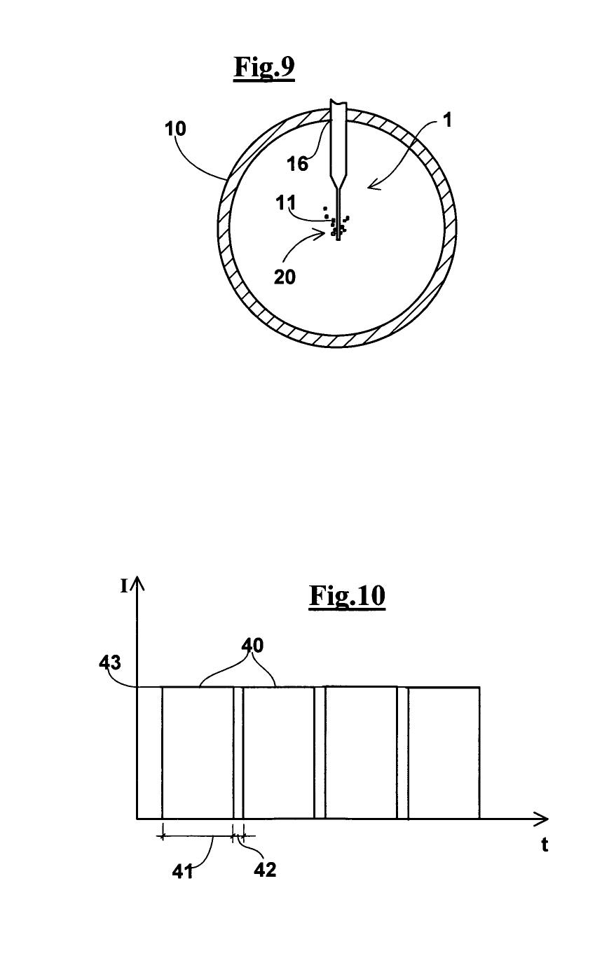

Since the sensor of FIGS. 1 and 2 comprises a heater, 24 and 25, the operation of sensor 20 and then the measurement steps heat the water that flows around creating vapour bubbles 11, shown in FIG. 9, some of which remain attached to the sensor, affecting the measurements.

In order to avoid this inconvenience, the present invention provides a method for measuring the water flow in a pipe 10 of water ducts, by piloting said sensor 20 in a pulsed way concerning the electric power that has to be dissipated by the sensor.

The steps of driving sensor 20 in a pulsed way is shown as an example in FIG. 10. This way, the measure is carried out intermittenthy, by alternating measuring step 40 and time outs without measurements.

In particular, by experimental tests an ideal time T1 has been found, indicated as 41, where sensor can be fed for 4 sec, after which it is advantageously not fed to allow the heat removal for a time T2, indicated as 42, larger than 100 msec.

Furthermore, the maximum temperature difference between the heating elements 24, 25 of sensor 20 and the water, beyond which the production occurs of bubbles of vapour and the deposit of calcium carbonate has been detected by tests as 50° C. Said pulsed operation keeps the sensor at a temperature difference with respect to water of 50° C., inhibiting the chemical reaction that turns Ca(HCO₃)₂ (bicalcium carbonate) into CaCO3(calcite-calcium carbonate)+CO₂+H₂O. The bicalcium carbonate is in fact soluble and tends to deposit in the as calcium carbonate for heating with loss of CO2.

The foregoing description of a specific embodiment will so fully reveal the invention according to the conceptual point of view, so that others, by applying current knowledge, will be able to modify and/or adapt for various applications such an embodiment without further research and without parting from the invention, and it is therefore to be understood that such adaptations and modifications will have to be considered as equivalent to the specific embodiment. The means and the materials to realise the different functions described herein could have a different nature without, for this reason, departing from the field of the invention. It is to be understood that the phraseology or terminology employed herein is for the purpose of description and not of limitation.

1. A water flow rate sensing device for measuring flow rate of water flow inside a water duct, comprising:
a solid state thermal sensor, said sensor having at least one electrical heater and at least one thermoresistance, said thermoresistance adapted to be kept at a same temperature as the water flow, said sensor being adapted to measure the flow rate by measuring temperature difference between said at least one heater and said at least one thermoresistance, such that an outlet signal proportional to said flow can be provided;
a support for said sensor, said support having an elongated shape with a first end and a second end, said sensor being connected at said first end of said support, said first end being adapted to be inserted in a hole that is made in said duct in order to support said sensor in an inner point of said duct in a zone of the water flow that is distant from the walls of the duct;
a fastening means to keep said support in said hole, so that said support has said first end in said duct; and
means for driving said electrical heater in a pulsed manner to permit heat to be dissipated by the sensor, such that production of bubbles of vapor on a surface of the sensor is avoided.

2-21. (canceled)

22. A device, according to claim 1, wherein said sensor is connected to said first end of said support by means of an extension plate, wherein said extension plate is integrally connected to said support at said first end and wherein said sensor is arranged on said extension plate opposite to said first end, said extension plate being adapted to be put in the water flow such that said extension plate holds said sensor distanced from said first end of said support.

23. A device, according to claim 222, wherein said extension plate has longitudinal electric paths for electrically connecting said sensor and said support.

24. A device, according to claim 22, wherein said extension plate comprises first electric contacts adapted to be coupled with respective electric contacts made in said support at said first end, said longitudinal electric paths connecting said first contacts of said extension plate with a housing for said sensor, in said housing said extension plate having second electric contacts for coupling to respective contacts present in said sensor.

25. A device, according to claim 1, wherein said extension plate can be made in different lengths responsive to the diameter of the duct where the flow rate sensor according to the invention has to be applied.

26. A device, according to claim 1, wherein said extension plate has a cross-section adapted to a fluidodynamic use, and said sensor is inserted at one end of said extension plate in order not to offer edges to the water flow, said extension plate having a recess for receiving said sensor, in particular said extension plate is made of ceramic or alumina and said paths are made with the thick film technology.

27. A device according to claim 1, wherein said sensing device comprises a means to supply electric energy to said sensor, said means to supply electric energy being selected from the group consisting of:
a battery integrated to said support;
an external source of electric energy connected to said sensing device at said second end of said support;
a self feeding device that uses the kinetic energy associated with the motion of the water in the duct, in particular, based on “energy harvesting” techniques.

28. A device, according to claim 1, wherein said sensing device comprises a means for transmitting a measuring signal to a remote central control unit, said means for transmitting being selected from the group consisting of:
a sender of electromagnetic signals associated with said sensing device and a remotely arranged receiver of electromagnetic signals, said receiver connected to said central control unit; and
an electric connection between said sensing device and said central control unit.

29. A device, according to claim 7, wherein said support has a tubular shape with closed ends, said support containing said battery and said means for transmitting, in particular said tubular support comprising a portion that can be opened for replacing the battery.

30. A method for measuring water flow in water ducts, by a water flow rate sensing device for water ducts having a thermal flow rate sensor, said method comprising the steps of:
arranging said sensor in the duct in order to be surrounded by the flow in a zone of the flow significant for the measure, in particular, in a zone sufficiently far from the walls of the duct, and
driving said sensor in a pulsed way with a signal at the electric power that has to be dissipated by the sensor, said step of driving comprising a succession of supply times having a duration T1, with time-outs having a duration T2 such that production of bubbles of vapor on the surface of the sensor can be avoided.

31. A method, according to claim 30, wherein at said duration T1 of said supply times, the power of the signal is changed by a feedback control capable of keeping a predetermined temperature difference between the heater of the sensor and the water, balancing the variation of the water flow rate with a suitable variation of the amplitude of the supply signal.

32. A device, according to claim 30, wherein said predetermined temperature difference is less than 50° C.

33. A method, according to claim 30, additionally comprising a step of discrimination of the direction of the water flow by the presence of two couples of heaters and thermoresistors.

34. A device, according to claim 30, wherein said supply time has a fixed duration T1 set between 0.1 and 8 seconds, preferably 4 seconds, and said time-outs have a duration T2 longer than 0.1 seconds.

35. A method for assembling a sensing device according to claim 1 to a duct, said support having a tubular elongated shape, and said method comprising the steps of:
providing a metal tubular collar, said collar having inner diameter equal to the outer diameter of support, and an appropriate length;
welding said collar out of a duct, said collar welded with its axis orthogonal to the side surface of said duct;
drilling said duct by a tip put in said collar, obtaining a hole made in said duct;
partly withdrawing said tip from said collar, and closing said collar by a block;
extracting the tip and introducing said extension member plate and said support;
extracting said block; and
causing said support to penetrate into the hole of the duct, in order to suitably position the lamina shaped plate in the duct.
